(19) United States
(12) Patent Application Publication
(10) Pub. No.: US 2026/0203616 A1
(43) Pub. Date: Jul. 16, 2026

(54) SYSTEMS AND METHODS FOR HIERARCHICAL PREDICTIONS

(71) Applicant: ODAIA Intelligence Inc., Toronto (CA)

(72) Inventors: Matthieu Marie Emmanuel Buot de l'Epine, Paris (FR); Pouyan Jahangiri Ardkapan, Langley (CA); Eric Kenneth Ross, Mississauga (CA)

(21) Appl. No.: 19/138,333

(22) PCT Filed: Nov. 27, 2023
(86) PCT No.: PCT/CA2023/051582

§ 371 Date: Jun. 12, 2025

Related U.S. Application Data
(60) Provisional application No. 63/431,923, filed on Dec. 12, 2022.

(51) Int. Cl. G06N 5/04

(52) U.S. Cl. CPC G06N 5/04

(57) ABSTRACT

Provided are computer-implemented systems and methods for hierarchical model-generation and hierarchical prediction. The computer-implemented method for generating a hierarchical model includes receiving a plurality of entity records; generating a binary hierarchy comprising at least three nodes based on the plurality of entity records; and generating the hierarchical model by: generating an intermediate hierarchical prediction, and performing a binary reconciliation. The computer-implemented method for generating a prediction with a hierarchical model includes: providing the hierarchical model; receiving a prediction request comprising 2024/124326 a prediction input that comprises an entity identifier; generating an input binary hierarchy based on the prediction input; generating a binary prediction output based on the input binary hierarchy and the hierarchical model; performing an inverse binary transform of the binary prediction; and determining a final prediction output based on the inverse binary transform.

This application claims the benefit of U.S. Provisional Ser. No. 63/431,923 , filed Dec. 12, 2022, the entire contents of which are incorporated by reference herein.

### FIELD

The described embodiments relate generally to systems and methods for generating hierarchical prediction models and making hierarchical predictions, and specifically to generating a hierarchical model for improving predictions based on hierarchical time series data.

### BACKGROUND

Machine learning models are frequently used as a tool for computer-based solutions to make predictions. The input and the output of machine-learning models may vary, but often can include sequences of multiple data points (variables) in time. For example, sequences of multiple data points may include measurements or data points arranged along a time-axis. In another example, the input and the output data can include time-based features, instead of being arranged along a time-axis. Other types of data, including non-time series-based data may also be used. In another example, the data may include static (non-time series) based features such as demographic, socio-economic, etc. attributes.

In many applications, the data has a hierarchical structure. At lower levels this can include data on individual people. This can also include upper levels of hierarchy that aggregate data from the lower levels. For example, geographical information about sales data for individual sales representatives collected at a low-level of the hierarchy may aggregate at other levels within the hierarchy, including at a regional level, a state or provincial level, or at a national level. This may include, for example, prescription information written for by a clinician from a set of clinicians. This may also include socio-economic data and demographic data.

In another example, individual low-level patient data may be aggregated at other levels within a hierarchy, including into an assigned clinician level, an account level (e.g. a pharmacy, long term home, hospital, facility, etc.), or at other levels within a medical organization.

In another example, a time hierarchy may aggregate seconds to minutes, minutes to hours, hours to days, days to weeks, weeks to months, months to year, etc.

In another example, individual low-level product data may be aggregated at other levels within a hierarchy, including into a market level, a product class level, a product sub-class level, and a product level.

Many other hierarchies may exist within time-series data, and the hierarchies may include aggregations of lower-level data at various levels in order to align with business needs.

Time series data having hierarchies may be used to generate machine learning models for forecasting the time-series data across all the levels of the given hierarchy. This is desirable because of aggregate patterns and information that is available within the hierarchy to improve the prediction quality across the entire hierarchy. Having data structured in a hierarchical time series can provide for improved prediction quality because of the availability of data at each level in the hierarchy, and the interrelations of the data to parent, siblings, and children.

Conventional approaches to forecasting using machine learning models based on hierarchical time-series data involve using individual models for each node in the hierarchy. This approach is problematic because the forecasts generated are often incoherent and inconsistent. For example, considering the aggregate prediction for sales within a geographical hierarchy. If forecasts generated for salespersons are modeled individually, situations can occur where the sum of the forecasts for all salespersons in a particular geographical area is incoherent with the forecast from the model for the geographical area itself. This is a case where the information and data inherent in the hierarchy is not incorporated or learned by the machine learning models underlying the forecasts.

Other conventional approaches have attempted to solve this problem by revising predictions at the time of inference. This is performed by generating base forecasts independently for each node in the hierarchy and combining or revising the base forecasts in a post-processing step to ensure coherence.

There are several issues that remain with this approach, however. First, the model parameters for nodes are learned independently by the respective independent models, which results in a loss of the hierarchical information. Second, the base forecasts are revised without the benefit of the hierarchical information.

Another conventional approach (Rangapuram, 2021) to probabilistic forecasting of hierarchical time series involves both learning and reconciliation into a single end-to-end model. In this approach, model parameters are learned simultaneously from all nodes in the hierarchy. This approach provides prediction coherence; however, this approach poses problems of its own. For instance, this approach requires hierarchical time-series data for model training which has a long time window, and further, requires hierarchical time-series data which is dense.

There is a need therefore for improved machine learning systems and methods that provide for generating hierarchical models and provide for generating coherent hierarchical predictions using hierarchical models. This can include generating hierarchical models for sparse and short time-series data and providing for generating coherent hierarchical predictions using hierarchical models.

### SUMMARY

Provided are systems and methods for generating hierarchical predictions.

In a first aspect there is provided a computer-implemented method for generating a hierarchical model, comprising: receiving a plurality of entity records, each entity record comprising an identifier user identifier, a timestamp, and three or more feature values; generating a binary hierarchy comprising at least three nodes based on the plurality of entity records, the at least three nodes comprising a parent node based on a first feature value in the three of more feature values, a first child node based on a second feature value in the three or more feature values, and a second child node based on a third feature value in the three of more feature values; and generating the hierarchical model by: generating an intermediate hierarchical prediction for the binary hierarchy based on the at least three nodes, and performing a binary reconciliation of the first child node, the second child node, and the parent node in the binary hierarchy.

In one or more embodiments, the plurality of entity records may comprise a hierarchical series, the hierarchical series comprising at least two hierarchy levels, the at least three nodes comprise at least four nodes comprising a parent node based on a first feature value in the three of more feature values, a first child node based on a second feature value in the three or more feature values, a second child node based on a third feature value in the three of more feature values, and a third child node based on a fourth feature value.

In one or more embodiments, the hierarchical series may comprise a hierarchical time series, the hierarchical time series comprising data for at least two time periods.

In one or more embodiments, the hierarchical time series may comprise a sparse hierarchical time series.

In one or more embodiments, the plurality of entity records may comprise at least one selected from the group of a plurality of user records, a plurality of healthcare provider records, a plurality of patient records, a plurality of product records, and a plurality of geographic records.

In one or more embodiments, the generating the binary hierarchy may comprise: determining a first left-one-out node corresponding to the first child node based on the sibling nodes of the first child node; and generating a first binary hierarchy may comprise the parent node, the first child node, and the first left-one-out node.

In one or more embodiments, the generating the intermediate hierarchical prediction may comprise: generating a parent node intermediate prediction, a first child node intermediate prediction, and a second child node intermediate prediction for the first binary hierarchy based on an intermediate hierarchical model; performing the binary reconciliation of the parent intermediate prediction, the first child node intermediate prediction, and the second child node intermediate prediction for the first binary hierarchy; and wherein the intermediate hierarchical prediction may comprise the parent node intermediate prediction, the first child node intermediate prediction, and the second child node intermediate prediction for the first binary hierarchy.

In one or more embodiments, the generating the binary hierarchy may comprise: determining a second left-one-out node corresponding to the second child node based on the sibling nodes of the second child node; and generating a second binary hierarchy comprising the parent node, the second child node, and a second left-one-out node corresponding to the second child node.

In one or more embodiments, the generating the intermediate hierarchical prediction may comprise: generating a parent node intermediate prediction, a first child node intermediate prediction, and a second child node intermediate prediction for the second binary hierarchy based on an intermediate hierarchical model; performing the binary reconciliation of the parent intermediate prediction, the first child node intermediate prediction, and the second child node intermediate prediction for the second binary hierarchy; and wherein the intermediate hierarchical prediction may comprise the parent node intermediate prediction, the first child node intermediate prediction, and the second child node intermediate prediction for the second binary hierarchy.

In one or more embodiments, the generating the binary hierarchy may comprise: generating a corresponding binary hierarchy for each corresponding child node, the corresponding binary hierarchy comprising a parent node, the corresponding child node, and a corresponding left-one-out node.

In one or more embodiments, the first left-one-out node may be determined by summing a feature value of each sibling nodes of the first child node; and the second left-one-out node may be determined by summing a feature value of each sibling nodes of the second child node.

In one or more embodiments, the binary reconciliation may comprise: determining a scaling factor for application to each node in a corresponding hierarchy; and applying the scaling factor to each node in the corresponding hierarchy.

In one or more embodiments, the generating the hierarchical model may comprise generating the hierarchical model using an XGBoost method.

In one or more embodiments, the method may further comprise updating one or more parameters of the intermediate hierarchical model.

In a second aspect, there is provided a computer-implemented system for hierarchical predictions, comprising: a memory; a network device; and a processor in communication with the memory and the network device, the processor configured to perform the method of one or more embodiments.

In a third aspect, there is provided a computer-readable media for hierarchical predictions, the computer-readable media having instructions for operating a processor to perform the method of one or more embodiments.

In a fourth aspect, there is provided a computer-implemented method for generating a prediction with a hierarchical model, comprising: providing, in a memory, the hierarchical model; receiving, at a network device, a prediction request comprising a prediction input that comprises an entity identifier; generating, at a processor in communication with the memory and the network device, an input binary hierarchy based on the prediction input; generating, at the processor, a binary prediction output based on the input binary hierarchy and the hierarchical model; performing an inverse binary transform of the binary prediction; and determining, at the processor, a final prediction output based on the inverse binary transform.

In one or more embodiments, the entity identifier may comprise at least one selected from the group of a user identifier, a healthcare provider identifier, a patient identifier, a product identifier, and a geographic identifier.

In one or more embodiments, the generating the binary prediction output may comprise: determining a prediction value for a node corresponding to the entity identifier, the prediction value based on a corresponding prediction of the node in a plurality of binary hierarchies.

In one or more embodiments, the prediction value for the node corresponding to the entity identifier may be based on a mean value of the corresponding prediction of the node in a plurality of binary hierarchies.

In one or more embodiments, the method may further comprise: performing a final reconciliation of the final prediction output.

In a fifth aspect, there is provided a computer-implemented system for generating a prediction with a hierarchical model, comprising: a memory; a network device; a processor in communication with the memory and the network device, the processor configured to perform the method of one or more embodiments.

In a sixth aspect, there is provided a computer-readable media for generating a prediction with a hierarchical model, the computer-readable media having instructions for operating a processor to perform the method of one or more embodiments.

### BRIEF DESCRIPTION OF THE DRAWINGS

A preferred embodiment of the present invention will now be described in detail with reference to the drawings, in which:

FIG. 1 is a system diagram showing a system for hierarchical predictions in accordance with one or more embodiments;

FIG. 2 is a device diagram in accordance with one or more embodiments;

FIG. 3 is a data schema diagram in accordance with one or more embodiments;

FIGS. 4A and 4B are historical data diagrams in accordance with one or more embodiments;

FIG. 5 is a hierarchical data diagram in accordance with one or more embodiments;

FIGS. 6A-6C are hierarchy diagrams in accordance with one or more embodiments;

FIGS. 6D-6F are binary hierarchy diagrams in accordance with one or more embodiments;

FIG. 7 is a model diagram in accordance with one or more embodiments;

FIG. 8 is a data diagram in accordance with one or more embodiments;

FIG. 9 is a method diagram in accordance with one or more embodiments;

FIG. 10 is a result diagram in accordance with one or more embodiments;

FIG. 11 is an error result diagram in accordance with one or more embodiments;

FIG. 12 is a user interface diagram in accordance with one or more embodiments;

FIG. 13 is a method diagram in accordance with one or more embodiments; and

FIG. 14 is another method diagram in accordance with one or more embodiments.

### DESCRIPTION OF VARIOUS EMBODIMENTS

Various apparatuses or methods will be described below to provide an example of the claimed subject matter. No example described below limits any claimed subject matter and any claimed subject matter may cover methods or apparatuses that differ from those described below. The claimed subject matter is not limited to apparatuses or methods having all of the features of any one apparatus or methods described below or to features common to multiple or all of the apparatuses or methods described below. It is possible that an apparatus or methods described below is not an example that is recited in any claimed subject matter. Any subject matter disclosed in an apparatus or methods described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It should also be noted that the terms “coupled”, or “coupling” as used herein can have several different meanings depending on the context in which these terms are used. For example, the terms “coupled”, or “coupling” can have a mechanical, electrical or communicative connotation. For example, as used herein, the terms “coupled”, or “coupling” can indicate that two elements or devices can be directly connected to one another or connected to one another through one or more intermediate elements or devices via an electrical element, electrical signal or a mechanical element depending on the particular context. Furthermore, the term “communicative coupling” indicates that an element or device can electrically, optically, or wirelessly send data to another element or device as well as receive data from another element or device.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112₁, 112₂, and 112₃). All elements with a common base number may be referred to collectively or generically using the base number without a suffix (e.g., 112).

The example systems and methods described herein may be implemented in hardware or software, or a combination of both. In some cases, the examples described herein may be implemented, at least in part, by using one or more computer programs, executing on one or more programmable devices comprising at least one processing element,a data storage element (including volatile and non-volatile memory and/or storage elements), and at least one communication interface. These devices may also have at least one input device (e.g., a keyboard, a mouse, a touchscreen, and the like), and at least one output device (e.g. a display screen, a printer, a wireless radio, and the like) depending on the nature of the device. For example, and without limitation, the programmable devices (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some examples, the communication interface may be a network communication interface. In examples in which elements are combined, the communication interface may be a software communication interface, such as those for inter-process communication (IPC). In still other examples, there may be a combination of communication interfaces implemented as hardware, software, and a combination thereof.

Program code may be applied to input data to perform the functions described herein and to generate output information. The output information is applied to one or more output devices, in known fashion.

Each program may be implemented in a high-level procedural, declarative, functional or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Examples of the system may also be considered to be implemented as a non-transitory computer-readable storage medium, configured with a computer program, where the storage medium so configured causes a computer to operate in a specific and predefined manner to perform the functions described herein.

Furthermore, the example system, processes and methods are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

Various examples of systems, methods and computer programs products are described herein. Modifications and variations may be made to these examples without departing from the scope of the invention, which is limited only by the appended claims. Also, in the various user interfaces illustrated in the figures, it will be understood that the illustrated user interface text and controls are provided as examples only and are not meant to be limiting. Other suitable user interface elements may be used with alternative implementations of the systems and methods described herein.

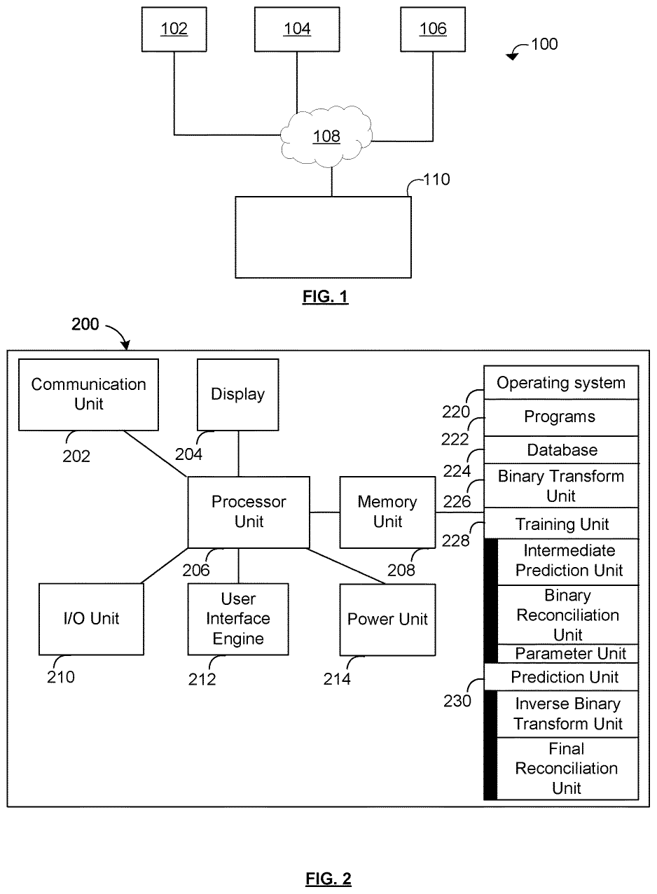

Reference is first made to FIG. 1, showing a system diagram 100 including a platform for generating hierarchical predictions in accordance with one or more embodiments. The system diagram 100 includes data sources 102, 104 and 106, network 108, and hierarchical prediction application 110, which may be used to generate hierarchical models and provide predictions using a hierarchical model.

The data sources 102, 104, and 106 may include data sets of prescribing behavior of healthcare professional (including records of prescriptions written by healthcare providers). The data sets of prescribing behavior may be provided by one or more data aggregators as are known. For example, the data sets may originate from a data source providing prescribing behavior data about HCPs. For example, the data may include Total Prescriptions (TRx), New Prescriptions (NRx), New-to-Brand Prescriptions (NBRx), patient count data, etc.

The data sources 102, 104 and 106 may be existing user systems such as those from CRM providers, event or transactional systems, product systems, or patient systems. The data sources may be accessible to application 110 via an Application Programming Interface (API) integration at network 108. A user of the application 110 may configure communication between the application 110 with the hierarchical prediction service.

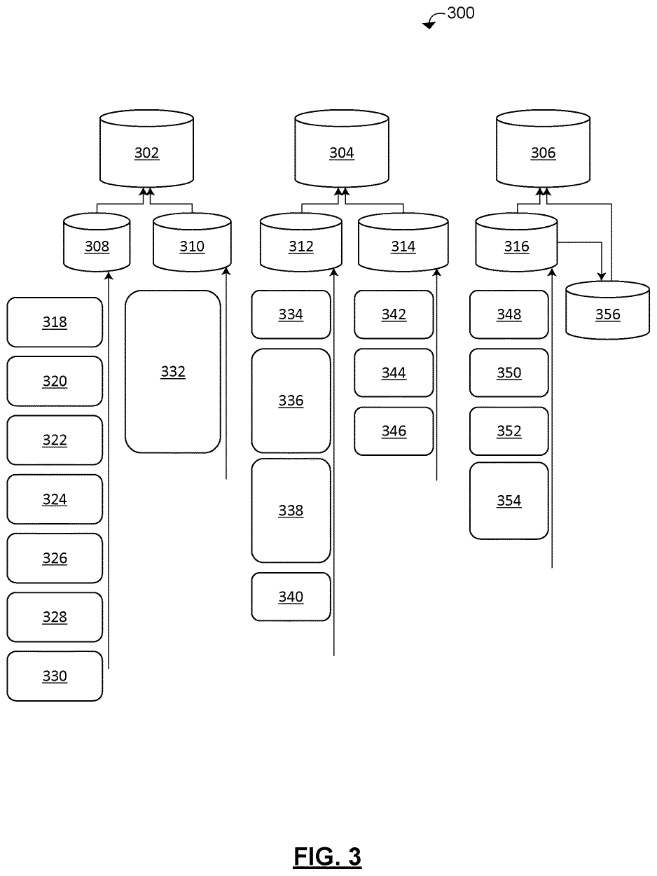

The data sources 102, 104 and 106 may include data sources having a variety of data sets. The data sets can include entity-based data, event based data, or time series data as described in FIG. 3.

Network 108 may be any network or network components capable of carrying data including the Internet, Ethernet, fiber optics, satellite, mobile, wireless (e.g. Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.) and others, including any combination of these.

The data sources 102, 104 and 106 may provide data sets to the application 110 via service APIs using network 108. The data sources 102, 104 and 106 may transmit information to the hierarchical prediction application 110 using an Application Programming Interface (API) which may either push data or pull the data. The format of the data provided using the API at data sources 102, 104 and 106 may be XML, JSON, or another interchange format as known. The data sources 102, 104 and 106 may transmit information to the application 110 using a periodic file transfer, for example, using secure File Transfer Protocol (sFTP), in either a push or a pull manner.

While the data sources 102, 104 and 106 are described herein as providing customer data from a customer relationship management platform, it is understood that the data sources 102, 104 and 106 may provide data from other sources, such as event data, or hierarchical time series data.

The data sources 102, 104 and 106 may include a database for storing the data sets. The data sources 102, 104 and 106 may include a Structured Query Language (SQL) database such as PostgreSQL or MySQL or a not only SQL (NoSQL) database such as MongoDB, or Graph Databases, etc.

The application 110 may be an application for marketing or sales professionals who interact with members of a market. For example, the marketing and sales professionals may be pharmaceutical sales professionals who interact with healthcare providers involved in prescribing pharmaceutical products. The user application 110 may provide reporting interfaces and predictions (including associated hierarchical predictions) to marketing or sales professionals about the prescribing behavior of healthcare professionals.

Alternatively, the application 110 may be an application for healthcare professionals who provide healthcare to the public. The healthcare professionals may interact with large medical organizations to provide healthcare throughout an institution having multiple departments which may be organized into a hierarchy. For example, a hierarchical reporting interface may be provided generating predictions of patient counts in the multiple departments within the medical organization.

Alternatively, the application 110 may be an application for pharmaceutical product predictions. This may include pharmaceuticals organized in a hierarchy for treating particular conditions as first line and second line treatments.

The user application 110 may be an application for head-office employees.

For example, user application 110 may be provided to users from a pharmaceutical company for generating predictions of pharmaceutical sales. The user application 110 may allow users to configure predictions and identify business objectives at the platform.

In another example, user application 110 may be provided to users from a medical organization with multiple departments for prediction of patient counts within the organization.

Application 110 capabilities may include machine learning capabilities which may provide hierarchical model generation and hierarchical prediction, which are described in further detail herein.

The user accessing user application 110 may do so using a user device (not shown) which may be any two-way communication device with capabilities to communicate with other devices. The user device may include, for example, a personal computer, a workstation, a portable computer or a mobile phone device. The user device may be used by a user to access reports and user interfaces provided by user application 110. User application 110 may include an application for use in the field by a user device or an application for use in an office by a user. The user application 110 may be a web application accessible over a network by various user devices or may be a client-server application including a mobile app available through the Google® Play Store® or the Apple® AppStore®. The user application 110 may enable access to the hierarchical predictions via APIs to the user.

The application 110 may run on a server such as the one described in FIG. 2, or it may operate on a service such as Amazon® Web Services®.

Reference is next made to FIG. 2, which shows a service device diagram 200 for a server such as the one running application 110 (see e.g., FIG. 1) in accordance with one or more embodiments. The server 200 includes a communication unit 202, a display 204, a processor unit 206, and a memory unit 208. The server 200 may further include an I/O unit 210 providing input/output at the server 200, a user interface engine 212 for providing user interfaces such as the one shown in FIG. 12 and a power unit 214 powering server 200.

The communication unit 202 operates to send and receive data via network 108 (see e.g., FIG. 1). This can include wired or wireless connection capabilities. The communication unit 202 can be used by the server 200 to communicate with other devices or computers. For example, the server 200 may use the communication unit 202 to communicate via network 108 with a data source (e.g., data sources 102, 104 and 106 in FIG. 1), and a user device (e.g. to access application 110).

The processor unit 206 controls the operation of the server 200. The processor unit 206 can be any suitable processor, controller or digital signal processor that can provide sufficient processing power depending on the configuration, purposes and requirements of the server 200 as is known by those skilled in the art. For example, the processor unit 206 may be a high-performance general processor. In alternative embodiments, the processor unit 206 can include more than one processor with each processor being configured to perform different dedicated tasks. In alternative embodiments, it may be possible to use specialized hardware to provide some of the functions provided by the processor unit 206. For example, the processor unit 206 may include a standard processor, such as an Intel® processor, or an AMD® processor.

The processor unit 206 can also generate various user interfaces. The user interfaces may be user interfaces such as the one found in FIG. 12 providing user access to the features of application 110 (see FIG. 1).

The server 200 may include a display 204 that may be an LED or LCD based display and may be a touch sensitive user input device that supports gestures.

The I/O unit 210 can include at least one of a mouse, a keyboard, a touch screen, a thumbwheel, a trackpad, a track-ball, a card-reader, voice recognition software and the like again depending on the particular implementation of the server 200.

The power unit 214 can be any suitable power source that provides power to the server 200 such as a power adaptor or a rechargeable battery pack depending on the implementation of the server 200 as is known by those skilled in the art.

The memory unit 208 comprises software code for implementing an operating system 220, various programs 222, database 224, binary transform unit 226, training unit 228 (including an intermediate prediction unit, a binary reconciliation unit, and a parameter unit), and prediction unit 230 (including inverse binary transform unit and final reconciliation unit).

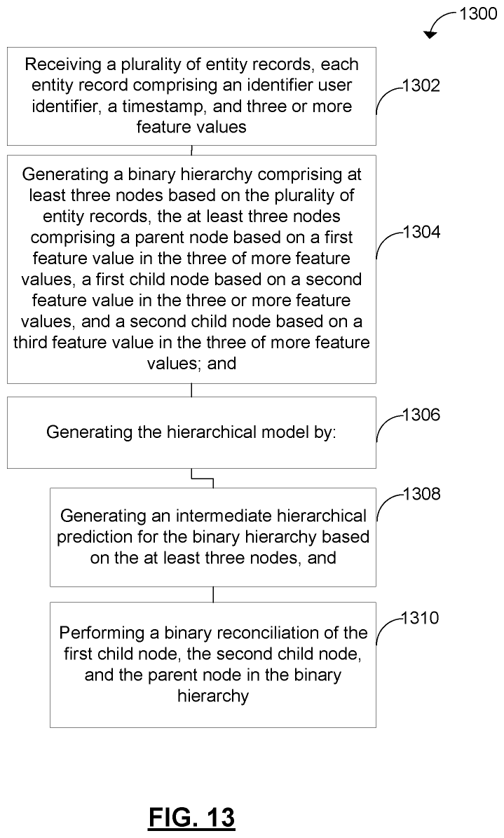

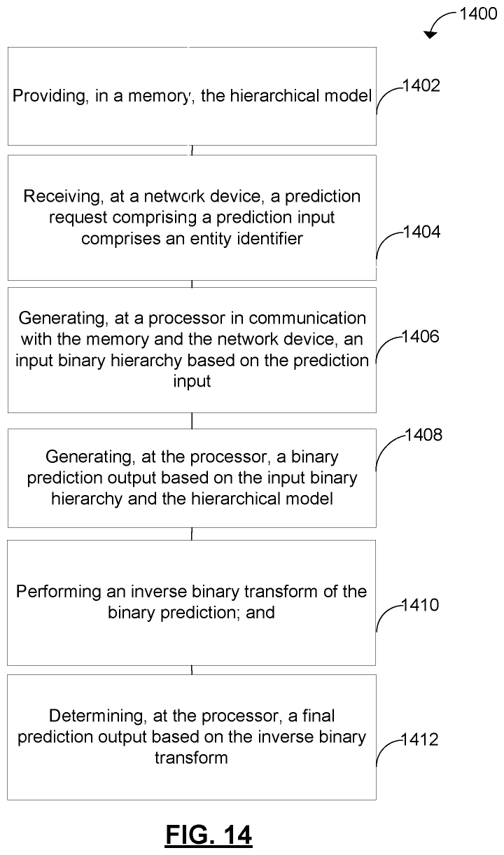

The memory unit 208 may include software code corresponding to the methods described herein. For example, software code corresponding to FIGS. 13 and 14 may be stored in the memory unit 208 and executed on processor unit 206.

The memory unit 208 can include RAM, ROM, one or more hard drives, one or more flash drives or some other suitable data storage elements such as disk drives, etc. The memory unit 208 is used to store an operating system 220 and programs 222 as is commonly known by those skilled in the art. For instance, the operating system 220 provides various basic operational processes for the server 200. For example, the operating system may be an operating system such as Windows® Server operating system, or Red Hat® Enterprise Linux (RHEL) operating system, or another operating system.

The programs 222 include various programs 222 so that the server 200 can perform various functions such as, but not limited to, receiving data sets from the data sources, providing APIs, training a hierarchical model, providing a user application, performing hierarchical predictions, and other functions as necessary.

The data sets may be received at communication unit 202, ingested at processor unit 206, and stored in database 224. The data sets received and stored in database 224 may include one or more hierarchical time series datasets. Database 224 may store data including the ingested data sets from data sources 102, 104 and 106 (see FIGS. 1 and 3). The database 224 may include a Structured Query Language (SQL) database such as PostgreSQL or MySQL or a not only SQL (NoSQL) database such as MongoDB, or Graph Databases, etc. The database 224 may run on the server 200 as shown or may also run independently on a database server in network communication with the server 200. The database 224 may be provided by server 200 as shown or may also run independently on a computing service such as Amazon® Web Services (AWS®) or Microsoft® Azure®.

The binary transform unit 226, training unit 228 (including an intermediate prediction unit, a binary reconciliation unit, and a parameter unit), and prediction unit 230 (including inverse binary transform unit and final reconciliation unit) cooperate to generate a hierarchical model and generate predictions using the generated hierarchical model.

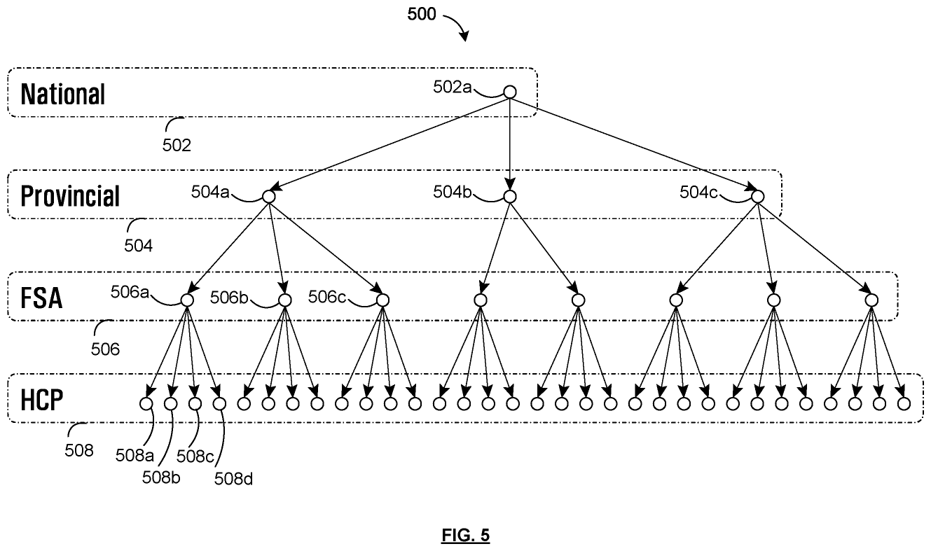

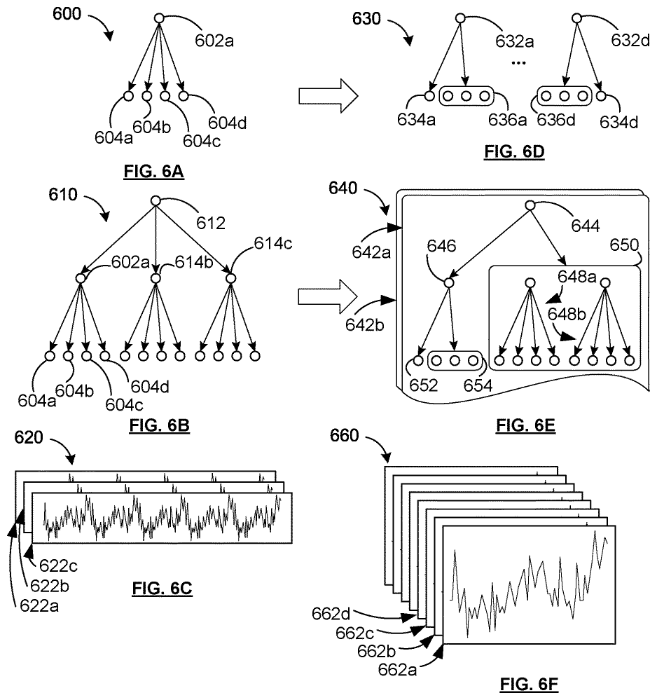

The binary transform unit 226 generates a binary hierarchy as discussed in FIGS. 5 and 6A-6F. The binary transform unit 226 may transform a data set in database 224 into a binary representation, for example, the binary transform unit 226 may transform one or more hierarchical time series datasets into a plurality of binary representations. The binary representation generated by the binary transform unit 226 may be a plurality of binary trees.

The training unit 228 (including an intermediate prediction unit, a binary reconciliation unit, and a parameter unit) generates a hierarchical model, for example as using the method discussed in FIG. 13. This may include generating an intermediate prediction using the intermediate prediction unit, performing a binary reconciliation of the intermediate prediction, and deriving and updating parameters using the parameter unit. The training unit 228 may perform model training for the plurality of binary representations generated by the binary transform unit 226.

The prediction unit 230 (including inverse binary transform unit and final reconciliation unit) uses a hierarchical model to generate a hierarchical prediction, for example, as discussed in FIG. 14. This can include performing an inverse binary transform and a final reconciliation.

Reference is next made to FIG. 3, which shows a data schema diagram 300 in accordance with one or more embodiments. The data schema may include data sets such as entity-based data set 302, event based data set 304 and time series based data set 306. Other types of data may also be included as known.

The data sets, including data sets 302, 304, and 306 may be received over a network from a variety of data sources. The data sets 302, 304 and 306 may be stored in database 224 (see e.g., FIGS. 1 and 2) and may store data including the ingested data sets from data sources 102, 104 and 106. The data sets 302, 304, and 306 may be stored in the database 224 (see e.g., FIG. 2) and may be provided by server 210 or may also run independently on a computing service such as Amazon® Web Services (AWS®) or Microsoft® Azure®. The data sets 302, 304, and 306 can include time-series datasets and data-sets that is not organized in a time series.

The entity data set 302 may include entity data related to many different entities associated with the CRM provider. This could include users of the CRM, clients and customers within the CRM data, sales and marketing staff in the CRM data, organizational units in the CRM, etc. The entity data set 302 may include user accounts, marketing campaigns, contacts, leads, opportunities, incidents, initiating subjects such as healthcare providers, products, patients, etc. These entities may be used to track and support sales, marketing, and service activities. An entity may have a set of attributes and each attribute may represent a data item of a particular type. For example, an account entity may have name, address, and owner identifier attributes.

The entity-based data 302 may include different entity type data 308 and entity contextual data 310 associated with the entity type data 308. Entity data may include accounts data 318, subject data (for example, for subjects such as health-care provider data) 320 and 322, patient data 324, internal team data 326, territories and geographical units data 328, and other unique ID data 330. An instance of entity contextual data 332 may include any contextual data related to the entity data 308. Entities may be referred to herein as subjects, initiating subjects, audience members, patients, internal team members, territories and geographical units. Entities may correspond to entity identifiers, subject identifiers, audience identifiers, etc.

The entity type data 308 may include data from a variety of entities. Accounts data 318 may include data about hospitals, clinics, labs, corporations and research groups. HCP data 320 and 322 may include data about physicians, nurses, pharmacists and midwives. Patient data 324 may be non-identifiable and may include patient population data, disease registries, health surveys and electronic health records. Internal team data 326 may include data about sales representatives, medical science liaisons and clinical representatives. Territories and geographical units data 328 may include data about geographical areas of interest such as medical centers, cities, provinces, states and countries. Other unique ID data 330 may include any entity data that is relevant to generating explainable predictions such as external team data, product data and disease data.

The entity contextual data 332 may include descriptive data associated with an entity such as a physician. This contextual data 332 may include metadata associated with the entities 308. The entity contextual data 332 may further include data related to gender, geography, locational demographics, specializations, education history and Key Opinion Leader (KOL) status.

The event-based data 304 may include time stamped data 312 and time-stamped contextual data 314. Time stamped data 312 may include CRM data 334, prior recommendation data 336 (for example, historical predictions or scores generated for entities), other generated events data 338 and other event data 340. The time stamped contextual data 314 may include metadata associated with the timestamped data 312. Time stamped contextual data 314 may include CRM topics and content data 342, scoring context data 344 and any other event contextual data 346.

The time stamped data 312 refers to data that is associated with a time stamp such as data about an interaction between a sales representative and a customer. CRM data 334 may include data from a range of communication channels, including a company's website, telephone, email, live chat, marketing materials and social media materials. Recommendation or scoring data 336 may include a numerical score associated with a customer to enable a user to compare the relative ranking of the different audiences and channels in the predictive report. The recommendation or scoring data 336 may include historical predictions and scores associated with each entity. The historical predictions may identify particular scores associated with the entities in entity data set 302 at different time stamps. The recommendation or scoring data 336 may be associated entity data. For example, a numerical score may be assigned to a physician at a certain time based on the data available up until that point. If the numerical score changes due to the introduction of new data, a new time stamped datapoint may be created. Other generated events data 338 may include the latest updated data. Other event data 340 may include interaction data between sales representatives and customers or clients, joining or leaving a particular segment or predictive segment, a change in HCP priority, patient referral, lab ordering, educational events, speaking arrangements and physician expenses with pharmaceutical companies.

The time stamped contextual data 314 may be categorical or numerical and may include descriptive data associated with time stamped data such as CRM data. CRM topics and content data 342 may include labels of CRM interactions such as “cold call” or “follow-up call”. Scoring context data 344 may include query history that led to the score generation and score calculation data. The scoring context data 344 may include information about whether the physician can be influenced to have a positive outcome for the objective based on the combination of channel and messaging topic. Other event contextual data 346 may include any contextual data associated with the variety of other event data 340.

The data 306 may include time series data 316 and time series features data 356. Time series data 316 may include transaction data 348 such as prescription data, claims data 350 converted to time series data, patient data 352 converted to time series data and engagement data 354. This may include, for example, prescription information written by a clinician in a set of clinicians. This may also include socio-economic data and demographic data.

The time series data 316 may include data that is tracked over a period of time. This can include transaction data 348 such as prescription data. The prescription data may include patient support program (PSP) data, third party data, prescription drug provider data and prescription device data. Converted claims data 350 may include data from independent instances of submitted claims that are converted into time series data. Converted patient data 352 may include data from independent instances of patient data that are converted into time series data. Converted claims data 350 and converted patient data 352 may include data about insurance claims or patient journey touchpoints that indicate the objectives in the project are being achieved. For example, converted claim data 350 may indicate that a pharmaceutical product is being bought. Engagement data 354 may include data for medical science liaisons and other non-prescription use cases. Engagement data 354 in the context of medical science liaising may include CRM interactions with an HCP. For example, this could be a face-to-face visit, an e-mail, or a speaking event.

The time series features data 356 may be extracted from the time series data 316 and may correspond to business objectives. The time series features data 356 may include features such as objective trend labels and window detection information. The time series features data 356 may be extracted automatically from the time-series data.

The entity-based data 302, event based data 304 and time series data 306 are gathered through a data ingest process and stored in a database 218 (see FIG. 2). This data is used to generate dynamically engineered data features which are, in turn, used to generate explainable predictions for customer relationship management.

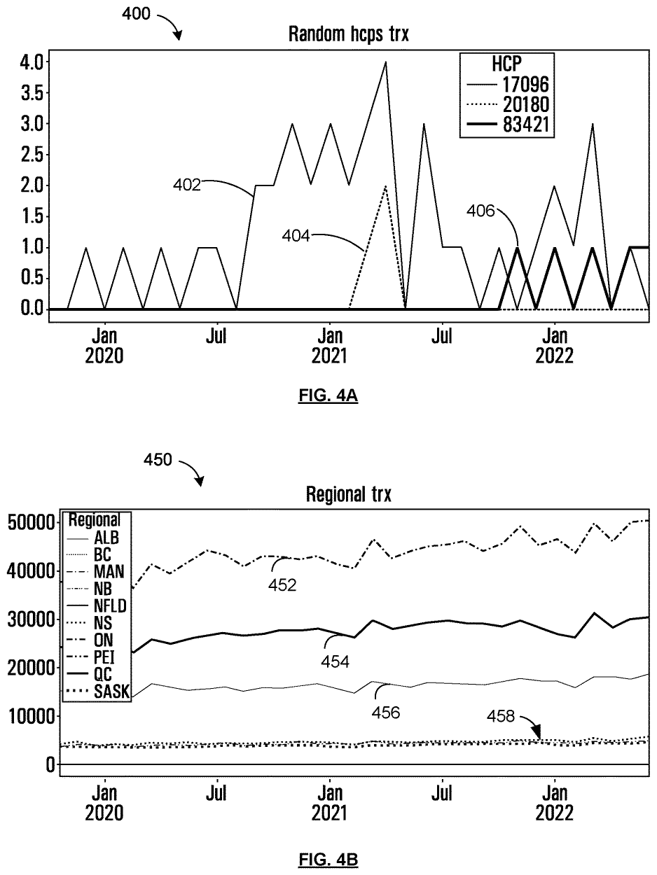

Referring next to FIGS. 4A and 4B, hierarchical time series data diagrams 400 and 450 are shown in accordance with one or more embodiments.

Data diagram 400 shows sparse bottom-level time series information for the number of prescription actions from three individual healthcare providers (17096, 20180, and 83421), including a first healthcare provider 402, a second healthcare provider 404, and a third healthcare provider 406. As shown, the time-series signals for each of the three healthcare providers are noisy and appear somewhat random.

Data diagram 450 shows time series for upper levels of the hierarchical time series. In this case, the time-series data has a geographical hierarchy, and the corresponding signals are shown for several different nodes in a geographical hierarchy. This time series data includes upper-level nodes for provinces, including the province of Ontario 452, the province of Quebec 454, the province of Alberta 456, and assorted other smaller provinces 458 including British Columbia, Manitoba, Newfoundland, Nova Scotia, Prince Edward Island and Saskatchewan.

FIG. 5 is a hierarchical data diagram 500 showing an example hierarchical time series in accordance with one or more embodiments. The hierarchy 500 has a national level 502, a provincial or state level 504, a forward sort address (FSA) level 506, and an individual healthcare provider level 508. The hierarchy 500 may be an m-ary tree (i.e., a tree having nodes a parent node with m child nodes), or another hierarchical structure.

The national level 502 includes a national node 502a. While only a single node is shown at the national level, there may be other national nodes for other countries. Further, there may be a root node that exists above the national level at a continental level, or another corresponding hierarchy level as known. The national level 502 may have a plurality of child provincial nodes at a provincial level 504.

The provincial or state level 504 includes a plurality of provincial nodes, such as a first provincial node 504a, a second provincial node 504b, and a third provincial node 504c. The first provincial node 504a, the second provincial node 504b and the third provincial node 504c may be, for example, province of Ontario 452, the province of Quebec 454, the province of Alberta 456, and assorted other smaller provinces 458 including British Columbia, Manitoba, Newfoundland, Nova Scotia, Prince Edward Island and Saskatchewan. The time series data for each node may correspond to the time series data, for example, as found in FIG. 4B. That is, the time series data for the province of Ontario 452 may correspond to the first provincial node 504a, the time series data for the province of Quebec 454 may correspond to the second provincial node 504b, and the time-series data for the province of Alberta 456 may correspond to the third provincial node 504c. Each provincial node at the provincial level 504 may have a plurality of child FSA nodes at an FSA level 506. While only three child provincial nodes 504 are shown for each national node 502, it is understood that there may be many more provincial child nodes 504 for each national node 502.

The forward sort address (FSA) level 506 may include a plurality of FSA nodes, including a first FSA node 506a, a second FSA node 506b, and a third FSA node 506c. Each FSA node at the FSA level 506 may have a plurality of child healthcare professional nodes at a healthcare professional level 508 (i.e., the bottom level). While only eight child FSA nodes 506 are shown for each provincial node 504, it is understood that there may be many more FSA child nodes 506 for each provincial node 504.

The healthcare professional (HCP) level 508 includes a plurality of healthcare professional nodes, including first HCP node 508a, second HCP node 508b, third HCP node 508c, and fourth HCP level 508d. While only four child HCP nodes are shown for each FSA node 506, it is understood that there may be many more HCP child nodes for each FSA node.

The hierarchy 500 as shown is based on a geographical hierarchy, however the hierarchy may be organized based on other criteria. For example, a product hierarchy may be used as described herein, a patient hierarchy may be used as described herein.

The hierarchical time series data received at application 110 (see FIG. 1) may include time series data corresponding to each node in hierarchy 500. The hierarchical time series data received at application 110 (see FIG. 1) may be used to generate the hierarchy 500.

Alternatively, the HCP nodes 508 may be organized in a hierarchy based on clinical role, segments associated with different healthcare providers (for example, marketing segments).

Referring next to FIGS. 6A-6B together, there is shown hierarchy diagrams 600 and 610 in accordance with one or more embodiments.

As shown in hierarchy 600, time series data can be converted into a time series hierarchy including a parent node 602a, and four child nodes 604a, 604b, 604c, 606d. This original hierarchy may have a relationship between a single parent node and many child nodes. This hierarchy may be representative to the actual hierarchy represented in the time series data.

As shown in hierarchy 610, the hierarchy 600 may form part of a deeper hierarchy including parent node 612, intermediate node 602a, intermediate sibling nodes 614b and 614c, along with child nodes 604a, 604b, 604c and 604d.

Referring to FIG. 6C, there is shown a data diagram 620 including plurality of time series data 622, including a first time series data 622a, a second time series data 622b, and a third time series data 622c as shown at 620 in FIG. 6C may be used to generate the hierarchies 600 and 610. Each time series in the plurality of time series 622 may correspond to a single node in the hierarchies 600 and 610. Each time series in the plurality of time series 622 may correspond to a single bottom-level node in the hierarchies 600 and 610.

The plurality of time series data 622 may be provided over a longer time horizon than the plurality of time series 662 (see e.g., FIG. 6F) and the data in the time series data 622 may be dense.

Referring next to FIG. 6D, there is a binary hierarchy diagram 630 based on hierarchy 600 in accordance with one or more embodiments. The binary hierarchy diagram 630 shows how the hierarchy 600 can be converted into a plurality of binary hierarchies.

The binary hierarchy diagram 630 shows a plurality of binary hierarchies that may be generated from hierarchy 600. The plurality of binary hierarchies includes a first binary hierarchy and a second binary hierarchy as shown, but it is understood that there may be many binary hierarchies generated from hierarchy 600. In one example, there is a binary hierarchy for each child (or bottom-level) node of hierarchy 600.

The first binary hierarchy has a parent node 632a, a first child node 634a and a first left-one-out node 636a. The parent node 632a may correspond to the parent node 602a of hierarchy 600 (see FIG. 6A). The first child node 634a may correspond to the child node 604a. The first left-one-out node 636a may correspond to an aggregation of the child nodes 604b, 604c, and 604d. The aggregation of the child nodes 604b, 604c, and 604d may include a sum or addition of the associated data, or another mathematical operation of the data associated with the associated nodes. The first binary hierarchy may be generated based on one or more of the time-series data 662 (see FIG. 6F).

The second binary hierarchy has a parent node 632d, a second left-one-out node 634d, and a second child node 636d. The parent node 632d may correspond to the parent node 602a of hierarchy 600 (see FIG. 6A). The second child node 634d may correspond to the child node 604d. The second left-one-out node 636d may correspond to an aggregation of the child nodes 604a, 604b, and 604c. The aggregation of the child nodes 604a, 604b, and 604c may include a sum or addition of the associated data, or another mathematical operation of the data associated with the associated nodes. The second binary hierarchy may be generated based on one of the time-series data 662 (see FIG. 6F).

Referring next to FIG. 6E, there is shown another binary hierarchy diagram 640 based on the hierarchy 610 in accordance with one or more embodiments. The binary hierarchy diagram 640 shows how the hierarchy 610 can be converted into a plurality of binary hierarchies 642.

The binary hierarchy diagram 640 shows a plurality of binary hierarchies 642 that may be generated from hierarchy 610. The plurality of binary hierarchies 642 may include a first binary hierarchy 642a and a second binary hierarchy 642b as shown, but it is understood that there may be many binary hierarchies generated from hierarchy 610. In one example, there is a binary hierarchy for each child (or bottom-level) node of hierarchy 610.

The first binary hierarchy 642a has a parent node 644, a first intermediate node 646, a first intermediate left-one-out node 650, a first child node 652 and a first child left-one-out node 654. The parent node 644 may correspond to the parent node 612 of hierarchy 610 (see FIG. 6B). The intermediate node 646 may correspond to the intermediate node 602a. The first intermediate left-one-out node 650 may correspond to an aggregation of the first sibling tree 648a including sibling node 614b and its associated child nodes, and second sibling tree 648b including sibling node 614c and its associated child nodes. The first child node 652 may correspond to the child node 604a. The first child left-one-out node 654 may correspond to an aggregation of the child nodes 604b, 604c, and 604d. The aggregation of the child nodes 604b, 604c, and 604d may include a sum or addition of the associated data, or another mathematical operation of the data associated with the associated nodes. The first binary hierarchy may be generated based on one or more of the time-series data 662 (see FIG. 6F).

Referring next to FIG. 6F, there is shown a data diagram 660 including plurality of time series data 662, including a first time series data 662a, a second time series data 662b, a third time series data 662c, a fourth time series data 662d as shown at 660 in FIG. 6F may be used to generate the hierarchies 630 and 640. Each time series in the plurality of time series 662 may correspond to a single node in the hierarchies 630 and 640. Each time series in the plurality of time series 662 may correspond to a single bottom-level node in the hierarchies 630 and 640.

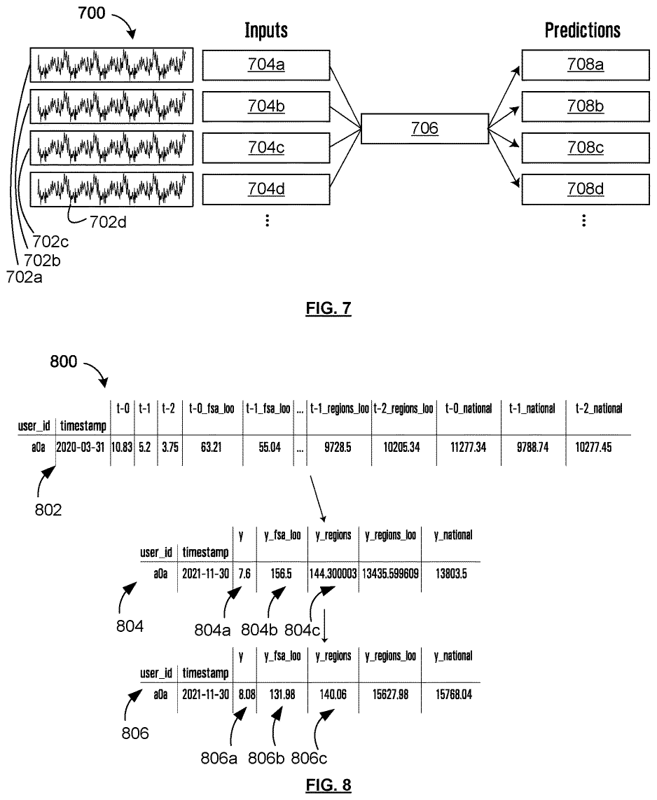

Referring next to FIG. 7, there is shown a model diagram 700 in accordance with one or more embodiments. The model 706 may be a hierarchical model for generating predictions 708 for a hierarchy, for example, hierarchies 600 and 610 (see e.g., FIGS. 6A and 6B) based on inputs 704. The model 700 may be a binary hierarchical model for generating predictions for a binary hierarchy (see e.g., FIGS. 6D and 6E).

The model 706 may receive at inputs 704 a plurality of time-series data 702, for example, time series data 702a, 702b, 702c and 702d. The plurality of time series data 702 may correspond to the time series data 662 (see FIG. 6F). The model 706 may be an XGBoost model, a Neural Network, a Recurrent Neural Network, a tree based model: Decision trees, Random Forest, Gradient boosted trees, for example: Catboost, LightGBM, or a linear/non-linear regression model.

The inputs 704 can include a child node input 704a (for example, an HCP node), a child node left-one-out node input 704b, an intermediate node input 704c (for example, an FSA node), an intermediate left-one-out node input 704d, and other inputs corresponding to the remaining nodes and left-one-out nodes as described in FIG. 6D and FIG. 6E.

The predictions 708 generated by the model 706 include a child node output 708a (for example, an HCP node), a child node left-one-out node output 708b, an intermediate node output 708c (for example, an FSA node), an intermediate left-one-out node output 708d, and other outputs corresponding to the remaining nodes and left-one-out nodes as described in FIG. 6D and FIG. 6E. The predictions 708 generated by the model 706 may include a prediction for each node and corresponding left-one-out node in the hierarchy (for example, in binary hierarchies 630 and 640 in FIGS. 6D and 6E).

The predictions 708 generated by the model 706 may be stored in a database such as database 224 (see FIG. 2).

Referring next to FIG. 8 is a data diagram 800 in accordance with one or more embodiments. Time series data from the one or more data sets stored in database 224 (see FIG. 2) may be prepared into a binary structure as shown in the data diagram 800. The data in data diagram 800 may have a single row per child node (i.e., HCP) per timestamp. The data in data diagram 800 includes an input data sample 802, a prediction 804 and a reconciled prediction 806.

The input data sample 802 may be the input to the model 706 (see FIG. 7). The input data sample 802 may include a row having columns for user_id (corresponding to an entity identifier for the child node, or HCP), timestamp, a measurement for the child node for time point t-0—the present value of the time series (i.e. for the HCP), t-1—the prior value of the time series for the child node, t-2—the second prior value of the time series for the child node, t-0_fsa_loo—the present value of the time series for the aggregated left-one-out value (i.e. for the remaining nodes in the FSA), t-1_fsa_loo—the prior value of the time series for the aggregated left-one-out value (i.e. for the remaining nodes in the FSA), t-2_fsa_loo—the second prior value of the time series for the aggregated left-one-out value (i.e. for the remaining nodes in the FSA), t-0_region—the present value of the time series for the region, t-1_region—the prior value of the time series for the region, t-2_region—the second prior value of the time series for the region, t-0_regions_loo—the present value of the time series for the left-one-out regions, t-1_regions_loo—the prior value of the time series for the left-one-out regions, t-2_regions_loo—the second prior value of the time series for the left-one-out region, t-0_national—the present value of the time series for the national level, t-1_national—the prior value of the time series for the national level, t-2_national—the second prior value of the time series for the national level. Optionally, where sales data is available across multiple countries, the data sample 802 may include t-0_national_loo—the present value of the time series for the aggregated left-one-out nations, t-1_national—the prior value of the time series for the aggregated left-one-out nations, t-2_national—the second prior value of the time series for the aggregated left-one-out nations.

The prediction 804 may be the output from the model 706 (see FIG. 7). The prediction output 804 may include a row having columns for user_id (corresponding to an entity identifier for the child node, or HCP), timestamp, a predicted value for the child node (i.e. the HCP), a predicted value for the aggregated left-one-out value of the child nodes (i.e. the remaining HCPs in the FSA), a predicted value for the region, a predicted value for the aggregated left-one-out regions, and a predicted national value.

As described in the Background section, the prediction 804 is an intermediate prediction and exhibits the incoherence in predictions. That is, the prediction for the child node 804a (i.e., the HCP) of 7.6 and the prediction for the remaining child nodes 804b (i.e., the remaining HCPs in the FSA) of 156.5 sum to 164.1. This sum is inconsistent from the predicted value for the region 804c of 144.3000003.

The reconciled prediction 806 is shown where the prediction 804 has had the intermediate prediction for the child node 806a, the aggregated left-one out intermediate prediction for the remaining child nodes 806b, and the parent node intermediate prediction 806c reconciled such that the parent node prediction 806c is consistent with the sum of the child node 806a and the aggregated left-one-out value 806b.

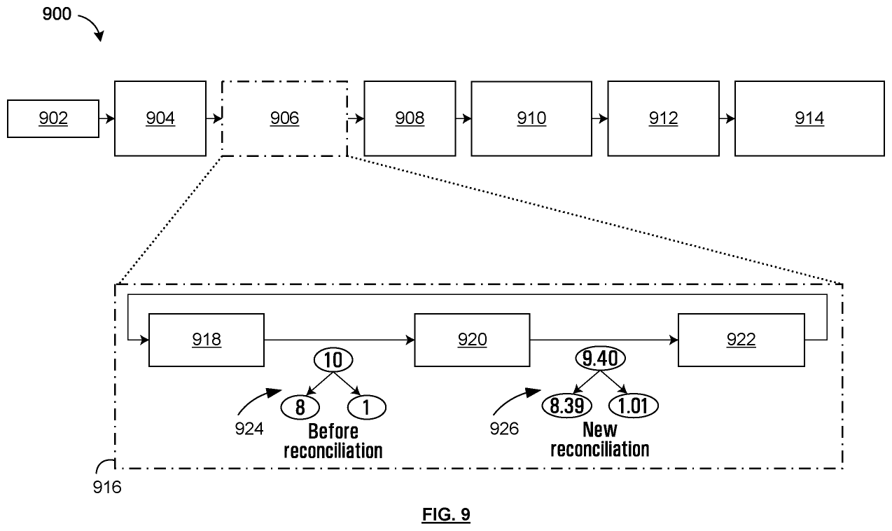

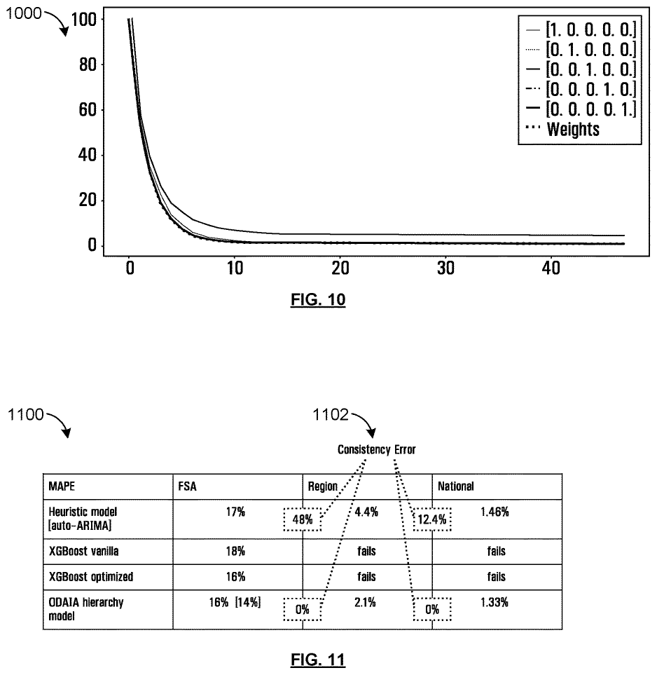

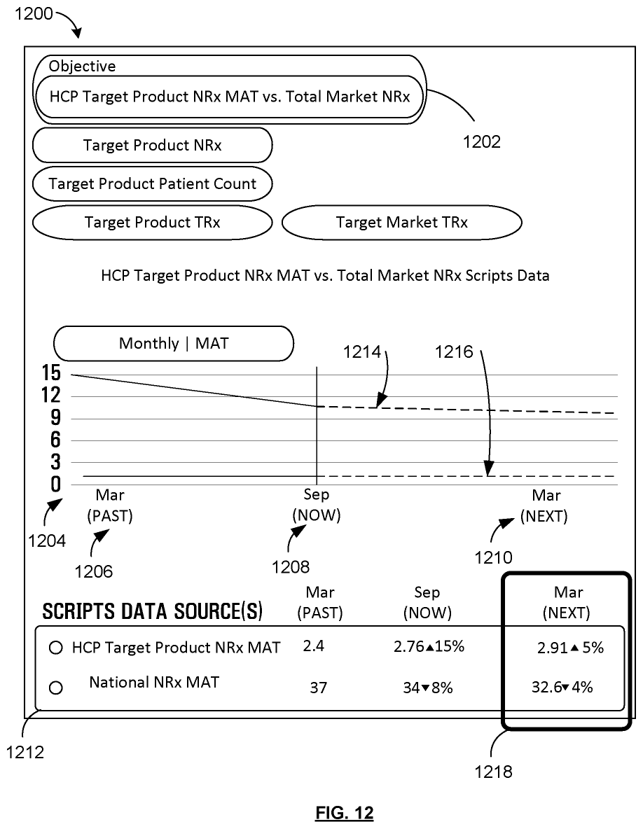

Referring next to FIG. 9 is a method diagram 900 in accordance with one or more embodiments.

At 902, an input dataset is received, such as one of the datasets stored in database 224 (see FIG. 2). The input dataset can include one or more time series data, including one or more hierarchical time series data. The hierarchical time series data may be provided in a hierarchy such as the one shown in FIG. 5, and FIGS. 6A-6B.

At 904, the time series data is converted into one or more binary hierarchies (for example, as described in FIGS. 6D-6E). The generation of the one or more binary hierarchies may be done by generating left-one-out nodes.

At 906, the hierarchical model is trained. This is shown in expanded view 916 showing the model training in detail, including generating intermediate predictions 918 (the intermediate prediction 924 is shown before reconciliation), performing binary reconciliation 920 (the reconciled intermediate prediction 926 is shown after reconciliation), and deriving and updating model parameters 922.

The generating intermediate predictions 918, the binary reconciliation 920, and deriving and updating model parameters 922 may be performed iteratively, including for each node in the hierarchy, for each binary hierarchy in the plurality of binary hierarchies, and for each child (bottom-level) node.

The generating intermediate predictions 918 generates the example intermediate prediction 924. As noted, the two child nodes of the intermediate prediction 924 are inconsistent. That is the first child node have a predicted value of 8 and the second child node having a predicted value of 1 are inconsistent with the parent node predicted value of 10.

The intermediate prediction 924 is reconciled using binary reconciliation 920, and the reconciled intermediate prediction 926 is shown after reconciliation 920. The binary reconciliation 920 operates to search for modifications to the intermediate predictions 924 that are provided for coherence and consistency within the binary hierarchy (as shown in the example reconciled binary hierarchy 926—where the sum of the predicted first child node value 8.39 and the predicted second child node value 1.01 are consistent with the predicted parent node value. These modifications may include searching for a scaling factor applied to each node in the binary hierarchy 924 to create the reconciled binary hierarchy 926. The reconciliation 920 may operate both down the binary hierarchy 924—resulting in the scaling of the predicted child node values based on the predicted parent node value, and up the binary hierarchy 924—resulting in the scaling of predicted parent node value based on the first child node value and the second child node value.

The reconciliation may preferentially modify larger predicted node values instead of smaller predicted node values, since such modifications cause a larger impact towards creating a reconciled binary hierarchy 926.

The derive and update parameters 922 may be, for example, a back-propagation operation during the model training, and may result in the updating of the model being trained to reflect the reconciled binary hierarchy 926.

The model training, including 902, 904, and 906 may be based on XGBoost or another machine learning model, with the addition of the use of the binary hierarchy and the binary reconciliation 920.

The model training, including 902, 904, and 906 are discussed further in FIG. 13.

At 908 a final prediction may be generated, the generated model from model training 906 may be used to generate a final prediction. The final prediction 908 may be generated by receiving an input time series, generating one or more input binary hierarchies, and using the hierarchical model to generate a prediction. The final prediction 908 may be a binary hierarchy. The input time series may be received as part of a prediction request from a user, for example, a user of application 110 (see FIG. 1).

The final prediction may have an inverse binary transformation 910 to return it to an output hierarchical time-series (for example, a hierarchy in the form of FIGS. 5 and 6A-6B).

At 912, a final reconciliation of the output hierarchical time series is performed, and at 914 the final prediction is output. The final prediction 914 may be stored in database 224 (see FIG. 2).

Referring next to FIG. 10, there is shown a result diagram 1000 in accordance with one or more embodiments.

The result diagram 1000 shows the validation error of the hierarchical model as it is trained during multiple iterations of model training 916 (see FIG. 9). Early stopping may be used during model training 916 to reduce the performance overhead of the training. The early stopping may also avoid over-fitting of the model to the data.

Referring next to FIG. 11, there is shown an error result diagram 1100 in accordance with one or more embodiments.

The rows in error result diagram 1100 correspond to four different models compared based on consistency error using the same dataset. The performance of the hierarchical model is shown in comparison to a heuristic model (auto-ARIMA), XGBoost vanilla, and XGBoost optimized. The columns of the table correspond to the levels of the hierarchical dataset.

The metric values shown in the table are the median absolute percentage error. This median absolute percentage error refers to the error of the predictions at each level. For example, if the predicted value is 110 and the true value is 100, a 10% error is recorded.

The consistency error 1102 is also shown corresponding to the error between the predictions of different levels, including comparing the aggregated child node predictions with the predicted value for the parent. As shown the heuristic model performed with a 48% consistency error between the FSA level and the region level, and 12.4% between the FSA level and the national level.

As shown, the hierarchical model shows a reduction in median absolute percentage error and a major improvement in consistency errors 1102.

Referring next to FIG. 12, there is shown a user interface diagram 1200 in accordance with one or more embodiments. The user interface may be provided by the user interface engine 212 (see FIG. 2) and provided over network 108 from application 110 to provide the prediction results to a user at a user device.

The hierarchical model may provide predictions as Moving Annual Total values. In an alternate embodiment, the output from the hierarchy model, may be an average value over a certain period of time into the future. For example, the output from the hierarchical model could be a 6-month average script volume prediction. In this case, the interface 1200 may take the 6-month prediction value and combine it with 6 months historical data to form a Moving Annual Total.

The prediction user interface 1200 may show Rx prescription data and Rx prescription predictions for a first target HCP, including an HCP Target Product NRx MAT vs. Total Market NRx graph 1204 as shown. A user may access user interface 1200 in order to compare the prescribing behavior of a single HCP to National prescribing behavior predictions, for example the NRx MAT. The MAT may include a prediction objective 1202 of HCP Target Product NRx MAT vs. Total Market NRx. The NRx Moving Annual Total (MAT) line graph 1204 may include a prior result 1206, a current result 1208, and a future prediction 1210 for a certain period of time in the future. For example, for several months ahead, if today is September 2022, then a future prediction period ending 6 months after September 2022.

The graph 1204 may show an HCP Target Product NRx MAT 1216 along with a national NRx MAT 1214, representing two levels of a hierarchy. Other levels of the hierarchy may be shown, or predictions for other nodes at other levels of the hierarchy. While the data shown in graph 1204 is NRx (New prescriptions), it is understood that other metrics may be provided as desired, including TRx (Total prescriptions), NBRx (New to Brand prescriptions), patient count, etc. The predictions 1218 may also correspond to these different metric types: NRx (New prescriptions), TRx (Total prescriptions), NBRx (New to Brand prescriptions), patient count, etc.

In addition to the graph 1204, a tabular format 1212 may be displayed including Rx prediction values for the prediction objective HCP Target Product NRx MAT vs. Total Market NRx 1202. Same as the line graph 1204, the user may review prior data and future predictions at different levels of the hierarchy of prediction outputs (e.g., Territory instead of National).

The display of graph 1204 and tabular format 1212 may be for different hierarchies, for example, an organization hierarchy, a product hierarchy, and a geographical hierarchy.

In the embodiment as shown in interface 1200, the hierarchy may be geographical hierarchy. Interface 1200 shows a displayed HCP Target Product NRx MAT row that may include, for example, the prescription information of Dr. John Smith for Product A. The second row may be a National MAT NRx of a National geographical hierarchy level of Product A (e.g., a the National Sales of Product A). A predicted future value 1218 may be provided for both the HCP Target Product NRx MAT row and the National MAT NRx. The tabular format 1212 may include rows corresponding to the HCP Target Product NRx MAT row and National MAT NRx. While the data shown is NRx (New prescriptions), it is understood that other metrics may be provided as desired, including TRx (Total prescriptions), NBRx (New to Brand prescriptions), patient count, etc. The predictions 1218 may also correspond to these different metric types: NRx (New prescriptions), TRx (Total prescriptions), NBRx (New to Brand prescriptions), patient count, etc.

In another embodiment where the hierarchy is an organizational hierarchy, the displayed HCP Target Product NRx MAT row may include, for example, the prescription information of Dr. John Smith for Product A. The second row may be an Organization MAT NRx of the parent organization hierarchy level for Product A (e.g., a clinic of Dr. John Smith). A predicted future value 1218 may be provided for both the HCP Target Product NRx MAT row and the Organization MAT NRx. The tabular format 1212 may include rows corresponding to the HCP Target Product NRx MAT row and Organization MAT NRx. While the data shown in tabular format 1218 is NRx (New prescriptions), it is understood that other metrics may be provided as desired, including TRx (Total prescriptions), NBRx (New to Brand prescriptions), patient count, etc. The predictions 1218 may also correspond to these different metric types: NRx (New prescriptions), TRx (total prescriptions), NBRx (new to brand prescriptions), patient count, etc.

In another embodiment where the hierarchy is product hierarchy, the displayed HCP Target Product NRx MAT row may include, for example, the prescription information of Dr. John Smith for Product A. The second row however may be an Product A Sub-class MAT NRx of a sub-class of Product A (e.g., a particular formulation of the Product A). A predicted future value 1218 may be provided for both the HCP Target Product NRx MAT row and the Product A Sub-class MAT NRx. The tabular format 1212 may include rows corresponding to the HCP Target Product NRx MAT row and Product A Sub-class MAT NRx. While the data shown is NRx (New prescriptions), it is understood that other metrics may be provided as desired, including TRx (Total prescriptions), NBRx (New to Brand prescriptions), patient count, etc. The predictions 1218 may also correspond to these different metric types: NRx (New prescriptions), TRx (Total prescriptions), NBRx (New to Brand prescriptions), patient count, etc.

As shown in interface 1200, the objective 1202 may be providing predictions for an individual HCP.

In another embodiment, instead of an objective 1202 that provides predictions for individual HCPs, objectives can include predictions for user categories or segments. The user categories or segments may be, for example, User Personas determined by Sales/Marketing executives/managers. The User Personas may be aggregated sets of HCPs identified by commonalities.

The user categories or segments may be determined based on a hierarchy type, for example, geographical areas (FSA's, territories), based on patients, based on accounts (pharmacies, LTC, hospitals), etc. The user category or segment hierarchy may incorporate a different hierarchy type than the one identified in the prediction objective 1202.

The prediction 1202 may be shown in user interface diagram 1200, and may include weekly, monthly, quarterly, or yearly future predictions of an entity within the hierarchy. For example, the interface 1200 may show the hierarchical predictions for the prescribing behavior for a particular pharmaceutical medication.

The user interface 1200 may further show a predicted time series, including a graph of predictions for several future time periods.

Referring next to FIG. 13, there is shown a method diagram 1300 in accordance with one or more embodiments.

At 1302, receiving a plurality of entity records, each entity record comprising an identifier, user identifier, a timestamp, and three or more feature values.

At 1304, generating a binary hierarchy comprising at least three nodes based on the plurality of entity records, the at least three nodes comprising a parent node based on a first feature value in the three of more feature values, a first child node based on a second feature value in the three or more feature values, and a second child node based on a third feature value in the three of more feature values.

At 1306, generating the hierarchical model, including 1308 and 1310.

At 1308, generating an intermediate hierarchical prediction for the binary hierarchy based on the at least three nodes.

At 1310, performing a binary reconciliation of the first child node, the second child node, and the parent node in the binary hierarchy.

Optionally, the plurality of entity records may include a hierarchical series, the hierarchical series comprising at least two hierarchy levels, the at least three nodes comprise at least four nodes comprising a parent node based on a first feature value in the three of more feature values, a first child node based on a second feature value in the three or more feature values, a second child node based on a third feature value in the three of more feature values, and a third child node based on a fourth feature value.

Optionally, the hierarchical series may include a hierarchical time series, the hierarchical time series comprising data for at least two time periods.

Optionally, the hierarchical time series may include a sparse hierarchical time series.

Optionally, the plurality of entity records may include at least one selected from the group of a plurality of user records, a plurality of healthcare provider records, a plurality of patient records, a plurality of product records, and a plurality of geographic records.

Optionally, the generating the binary hierarchy may include determining a first left-one-out node corresponding to the first child node based on the sibling nodes of the first child node; and generating a first binary hierarchy including the parent node, the first child node, and the first left-one-out node.

Optionally, the generating the intermediate hierarchical prediction may include: generating a parent node intermediate prediction, a first child node intermediate prediction, and a second child node intermediate prediction for the first binary hierarchy based on an intermediate hierarchical model; performing the binary reconciliation of the parent intermediate prediction, the first child node intermediate prediction, and the second child node intermediate prediction for the first binary hierarchy; and wherein the intermediate hierarchical prediction comprises the parent node intermediate prediction, the first child node intermediate prediction, and the second child node intermediate prediction for the first binary hierarchy.

Optionally, the generating the binary hierarchy may include determining a second left-one-out node corresponding to the second child node based on the sibling nodes of the second child node; and generating a second binary hierarchy comprising the parent node, the second child node, and a second left-one-out node corresponding to the second child node.

Optionally, the generating the intermediate hierarchical prediction may include: generating a parent node intermediate prediction, a first child node intermediate prediction, and a second child node intermediate prediction for the second binary hierarchy based on an intermediate hierarchical model; performing the binary reconciliation of the parent intermediate prediction, the first child node intermediate prediction, and the second child node intermediate prediction for the second binary hierarchy; and wherein the intermediate hierarchical prediction comprises the parent node intermediate prediction, the first child node intermediate prediction, and the second child node intermediate prediction for the second binary hierarchy.

Optionally, the generating the binary hierarchy may include generating a corresponding binary hierarchy for each corresponding child node, the corresponding binary hierarchy comprising a parent node, the corresponding child node, and a corresponding left-one-out node.

Optionally, the first left-one-out node may be determined by summing a feature value of each sibling nodes of the first child node; and the second left-one-out node may be determined by summing a feature value of each sibling nodes of the second child node.

Optionally, the binary reconciliation may include determining a scaling factor for application to each node in a corresponding hierarchy; and applying the scaling factor to each node in the corresponding hierarchy.

Optionally, the generating the hierarchical model may include generating the hierarchical model using an XGBoost method.

Optionally, the method may further include updating one or more parameters of the intermediate hierarchical model.

Referring next to FIG. 14, there is shown another method diagram 1400 in accordance with one or more embodiments.

At 1402, providing, in a memory, the hierarchical model.

At 1404, receiving, at a network device, a prediction request comprising a prediction input comprises an entity identifier.

At 1406, generating, at a processor in communication with the memory and the network device, an input binary hierarchy based on the prediction input.

At 1408, generating, at the processor, a binary prediction output based on the input binary hierarchy and the hierarchical model.

At 1410, performing an inverse binary transform of the binary prediction.

At 1412, determining, at the processor, a final prediction output based on the inverse binary transform.

Optionally, the entity identifier may include at least one selected from the group of a user identifier, a healthcare provider identifier, a patient identifier, a product identifier, and a geographic identifier.

Optionally, the generating the binary prediction output may include determining a prediction value for a node corresponding to the entity identifier, the prediction value based on a corresponding prediction of the node in a plurality of binary hierarchies.

Optionally, the prediction value for the node corresponding to the entity identifier may be based on a mean value of the corresponding prediction of the node in a plurality of binary hierarchies.

Optionally, the method may further include performing a final reconciliation of the final prediction output.

The present invention has been described herein by way of example only. Various modification and variations may be made to these exemplary embodiments without departing from the spirit and scope of the invention, which is limited only by the appended claims.

1) A computer-implemented method for generating a hierarchical model, comprising:
receiving a plurality of entity records, each entity record comprising an identifier, a timestamp, and three or more feature values;
generating a binary hierarchy comprising at least three nodes based on the plurality of entity records, the at least three nodes comprising a parent node based on a first feature value in the three of more feature values, a first child node based on a second feature value in the three or more feature values, and a second child node based on a third feature value in the three of more feature values; and
generating the hierarchical model by:
generating an intermediate hierarchical prediction for the binary hierarchy based on the at least three nodes, and
performing a binary reconciliation of the first child node, the second child node, and the parent node in the binary hierarchy.

2) The method of claim 1), wherein the plurality of entity records comprises a hierarchical series, the hierarchical series comprising at least two hierarchy levels, the at least three nodes comprise at least four nodes comprising a parent node based on a first feature value in the three of more feature values, a first child node based on a second feature value in the three or more feature values, a second child node based on a third feature value in the three of more feature values, and a third child node based on a fourth feature value.

3) The method of claim 2), wherein the hierarchical series comprises a hierarchical time series, the hierarchical time series comprising data for at least two time periods.

4) (canceled)

5) (canceled)

6) The method of claim 1), wherein the generating the binary hierarchy comprises:
determining a first left-one-out node corresponding to the first child node based on the sibling nodes of the first child node; and
generating a first binary hierarchy comprising the parent node, the first child node, and the first left-one-out node.

7) The method of claim 6), wherein the generating the intermediate hierarchical prediction comprises:
generating a parent node intermediate prediction, a first child node intermediate prediction, and a second child node intermediate prediction for the first binary hierarchy based on an intermediate hierarchical model;
performing the binary reconciliation of the parent intermediate prediction, the first child node intermediate prediction, and the second child node intermediate prediction for the first binary hierarchy; and
wherein the intermediate hierarchical prediction comprises the parent node intermediate prediction, the first child node intermediate prediction, and the second child node intermediate prediction for the first binary hierarchy.

8) The method of claim 7), wherein the generating the binary hierarchy comprises:
determining a second left-one-out node corresponding to the second child node based on the sibling nodes of the second child node; and
generating a second binary hierarchy comprising the parent node, the second child node, and a second left-one-out node corresponding to the second child node.

9) The method of claim 8), wherein the generating the intermediate hierarchical prediction comprises:
generating a parent node intermediate prediction, a first child node intermediate prediction, and a second child node intermediate prediction for the second binary hierarchy based on an intermediate hierarchical model;
performing the binary reconciliation of the parent intermediate prediction, the first child node intermediate prediction, and the second child node intermediate prediction for the second binary hierarchy; and
wherein the intermediate hierarchical prediction comprises the parent node intermediate prediction, the first child node intermediate prediction, and the second child node intermediate prediction for the second binary hierarchy.

10) The method of claim 9), wherein the generating the binary hierarchy comprises:
generating a corresponding binary hierarchy for each corresponding child node, the corresponding binary hierarchy comprising a parent node, the corresponding child node, and a corresponding left-one-out node.

11) The method of claim 10), wherein:
the first left-one-out node is determined by summing a feature value of each sibling nodes of the first child node; and
the second left-one-out node is determined by summing a feature value of each sibling nodes of the second child node.

12) The method of claim 7), wherein the binary reconciliation comprises:
determining a scaling factor for application to each node in a corresponding hierarchy; and
applying the scaling factor to each node in the corresponding hierarchy.

13) (canceled)

14) (canceled)

15) system for hierarchical predictions, comprising:
a memory;
a network device;
a processor in communication with the memory and the network device, the processor configured to:
receive a plurality of entity records, each entity record comprising an identifier, a timestamp, and three or more feature values;
generate a binary hierarchy comprising at least three nodes based on the plurality of entity records, the at least three nodes comprising a parent node based on a first feature value in the three of more feature values, a first child node based on a second feature value in the three or more feature values, and a second child node based on a third feature value in the three of more feature values; and
generate the hierarchical model by:
generating an intermediate hierarchical prediction for the binary hierarchy based on the at least three nodes, and
performing a binary reconciliation of the first child node, the second child node, and the parent node in the binary hierarchy.

16) A computer-readable media for hierarchical predictions, the computer-readable media having instructions for operating a processor to:
receive a plurality of entity records, each entity record comprising an identifier, a timestamp, and three or more feature values;
generate a binary hierarchy comprising at least three nodes based on the plurality of entity records, the at least three nodes comprising a parent node based on a first feature value in the three of more feature values, a first child node based on a second feature value in the three or more feature values, and a second child node based on a third feature value in the three of more feature values; and
generate the hierarchical model by:
generating an intermediate hierarchical prediction for the binary hierarchy based on the at least three nodes, and
performing a binary reconciliation of the first child node, the second child node, and the parent node in the binary hierarchy.

17) A computer-implemented method for generating a prediction with a hierarchical model, comprising:
providing, in a memory, the hierarchical model;
receiving, at a network device, a prediction request comprising a prediction input comprising an entity identifier;
generating, at a processor in communication with the memory and the network device, an input binary hierarchy based on the prediction input;
generating, at the processor, a binary prediction output based on the input binary hierarchy and the hierarchical model;
performing an inverse binary transform of the binary prediction; and
determining, at the processor, a final prediction output based on the inverse binary transform.

18) (canceled)

19) (canceled)

20) (canceled)

21) (canceled)

22) A system for generating a prediction with a hierarchical model, comprising:
a memory containing the hierarchical model;
a network device configured to receive a prediction request comprising a prediction input comprising an entity identifier; and
a processor in communication with the memory and the network device, the processor configured to:
generate an input binary hierarchy based on the prediction input;
generate a binary prediction output based on the input binary hierarchy and the hierarchical model;
perform an inverse binary transform of the binary prediction; and
determine a final prediction output based on the inverse binary transform.

23) A computer-readable media for generating a prediction with a hierarchical model, the computer-readable media having instructions for operating a processor to:
receive a prediction request comprising a prediction input comprising an entity identifier;
generate an input binary hierarchy based on the prediction input;
generate a binary prediction output based on the input binary hierarchy and the hierarchical model;
perform an inverse binary transform of the binary prediction; and
determine a final prediction output based on the inverse binary transform.

24) The system of claim 15, wherein the plurality of entity records comprises a hierarchical series, the hierarchical series comprising at least two hierarchy levels, the at least three nodes comprise at least four nodes comprising a parent node based on a first feature value in the three of more feature values, a first child node based on a second feature value in the three or more feature values, a second child node based on a third feature value in the three of more feature values, and a third child node based on a fourth feature value.

25) The system of claim 15, wherein the processor is further configured to generate the binary hierarchy by:
determining a first left-one-out node corresponding to the first child node based on the sibling nodes of the first child node; and
generating a first binary hierarchy comprising the parent node, the first child node, and the first left-one-out node.

26) The system of claim 25, wherein the processor is further configured to generate the intermediate hierarchical prediction by:
generating a parent node intermediate prediction, a first child node intermediate prediction, and a second child node intermediate prediction for the first binary hierarchy based on an intermediate hierarchical model;
performing the binary reconciliation of the parent intermediate prediction, the first child node intermediate prediction, and the second child node intermediate prediction for the first binary hierarchy; and
wherein the intermediate hierarchical prediction comprises the parent node intermediate prediction, the first child node intermediate prediction, and the second child node intermediate prediction for the first binary hierarchy.

27) The system of claim 26, wherein the processor is further configured to generate the binary hierarchy by:
determining a second left-one-out node corresponding to the second child node based on the sibling nodes of the second child node; and
generating a second binary hierarchy comprising the parent node, the second child node, and a second left-one-out node corresponding to the second child node.

28) The system of claim 26, wherein the performing the binary reconciliation comprises:
determining a scaling factor for application to each node in a corresponding hierarchy; and
applying the scaling factor to each node in the corresponding hierarchy.
